(19) United States
(12) Patent Application Publication
(10) Pub. No.: US 2003/0169287 A1
(43) Pub. Date: Sep. 11, 2003

(54) Workstation-type mini computer capable of switching key-in devices and output display monitors

(76) Inventor: Jefferson Liu, Taichung (TW)

Correspondence Address: PRO-TECHTOR INTERNATIONAL, 20775 Norada Court, Saratoga, CA, 95070-3018, US

(21) Appl. No.: 10/382,288

(22) Filed: Mar. 4, 2003

(30) Foreign Application Priority Data
Mar. 7, 2002 (TW) 91202692

(51) Int. Cl. G09G 5/00

(52) U.S. Cl. 345/718; 345/864

(57) ABSTRACT

A workstation-type mini computer comprises a motherboard, a small display, a wired receiving interface, a wireless receiving interface, and a wireless audio-video signal transmitter. The motherboard has at least one processor. The wired receiving interface receives signals from an external wired key-in device, which can be a keyboard, a mouse, or a touch-control panel, through an electric cable; the electric cable bridges the wired receiving interface and the external wired key-in device. The wireless receiving interface receives signals from an external wireless key-in device, which can be a keyboard, a mouse, or a touch-control panel, by a wireless transmission means. The wireless audio-video signal transmitter transmits output audio-video signals generated in the motherboard to a wireless audio-video signal receiver; the wireless audio-video signal receiver receives and then relays the output audio-video signals to a large-scaled display monitor for display.

### FIELD OF THE INVENTION

The present invention relates to a mini computer, and particular to a workstation-type mini computer capable of switching key-in devices and output display monitors.

### BACKGROUND OF THE INVENTION

In spite of its portability, a conventional mini electronic device having the function of a computer, such as a handheld computer, a personal digital assistant (PDA), and a mobile phone, is not easy to use in many situations. For example, running a computer game usually requires a large display monitor and a special key-in device, which are absent in those mini electronic devices. Take another example; inputting a large amount of text materials to those mini electronic devices using their built-in key-in devices is painful. The design concepts of those mini electronic devices inevitably result in a user's inconvenience in the situations when the key-in function or the output display of a workstation-type computer is needed. This present invention aims at overcoming the shortcomings of the conventional mini electronic devices, so that they can be converted to a workstation-type computer by switching key-in devices and output display monitors.

### SUMMARY OF THE INVENTION

Accordingly, the primary object of the present invention is to provide a workstation-type mini computer in which the convenience of a computer-type small electronic device and the advantage of a conventional workstation-type computer are integrated.

To achieve the above object, the present invention provides a workstation-type mini computer capable of switching key-in devices and output display monitors which includes a motherboard having at least a processor, a small display connected to the motherboard, and a wired and a wireless receiving interfaces, both connected to the motherboard. The wired receiving interface receives electric signals through an electric cable from an external wired key-in device (either of a keyboard, a mouse, and a touch-control panel), whereas the wireless receiving interface receives electric signals from an external wireless key-in device (either of a keyboard, a mouse, and a touch-control panel) by a wireless transmission means. The workstation-type mini computer further includes a wireless audio-video (AV) signal transmitter that is used for transmitting the contents of an output AV signal from the motherboard to a wireless audio-video signal receiver connected to an external large-scaled display monitor.

The various objects and advantages of the present invention will be more readily understood from the following detailed description when read in conjunction with the appended drawings.

### BRIEF DESCRIPTION OF THE DRAWINGS

FIG. 1 shows the system block diagram of the present invention of a workstation-type mini computer.

FIG. 2a is a perspective view of an embodiment of the present invention as a handheld computer, according to the structure of the present invention shown in FIG. 1.

FIG. 2b is a perspective view of an embodiment of the present invention as a personal digital assistant (PDA), according to the structure of the present invention shown in FIG. 1.

FIG. 2c is a perspective view of an embodiment of the present invention as a mobile phone, according to the structure of the present invention shown in FIG. 1.

### DETAILED DESCRIPTION OF THE PREFERRED EMBODIMENTS

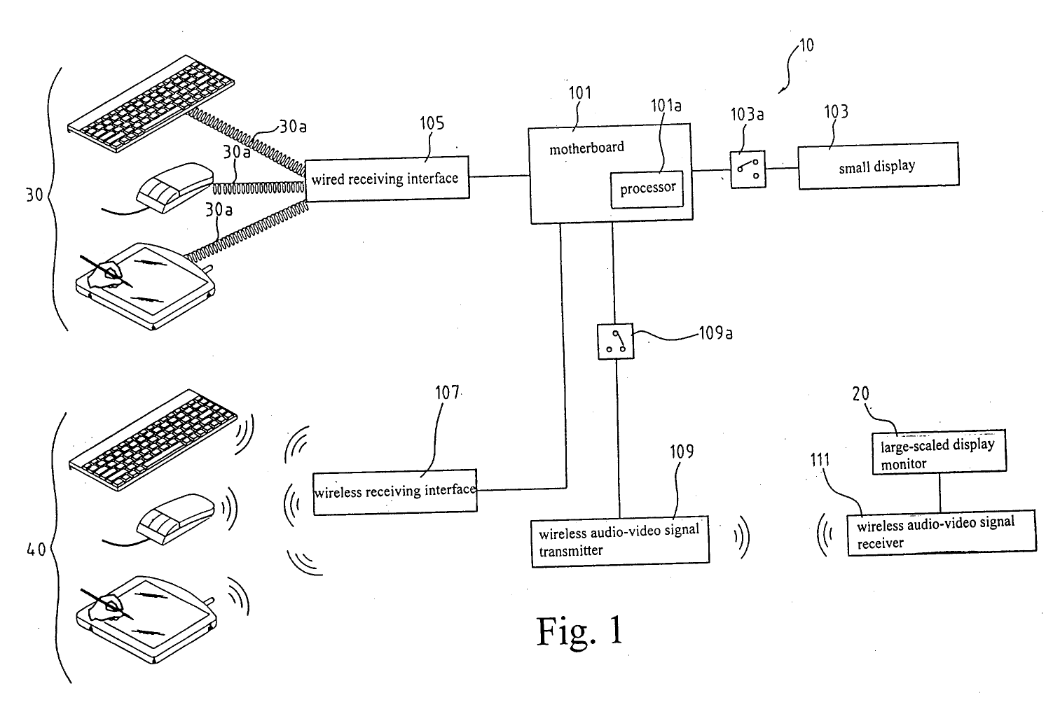

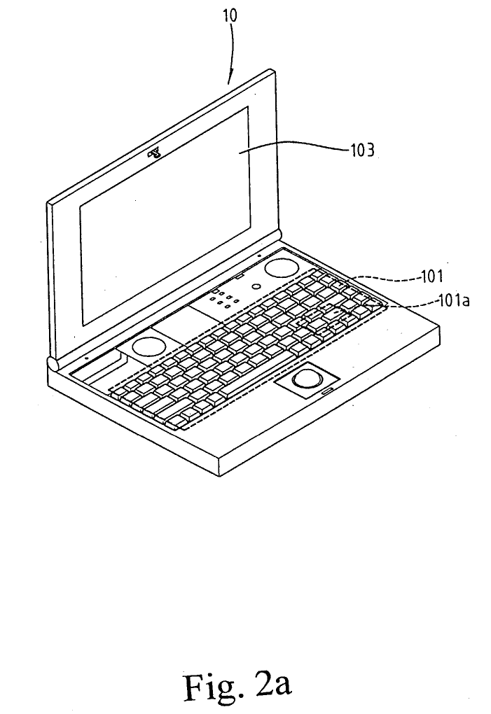

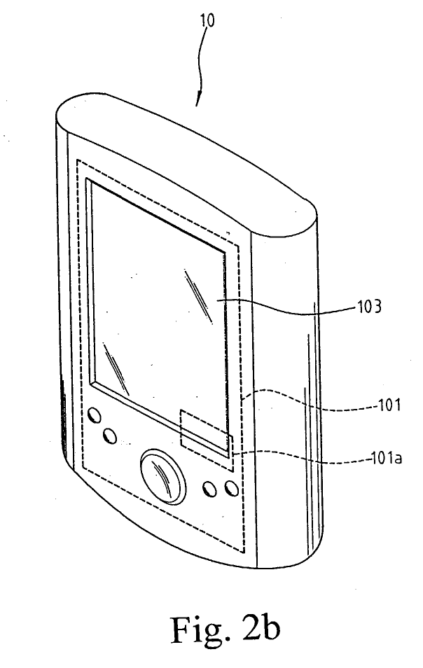

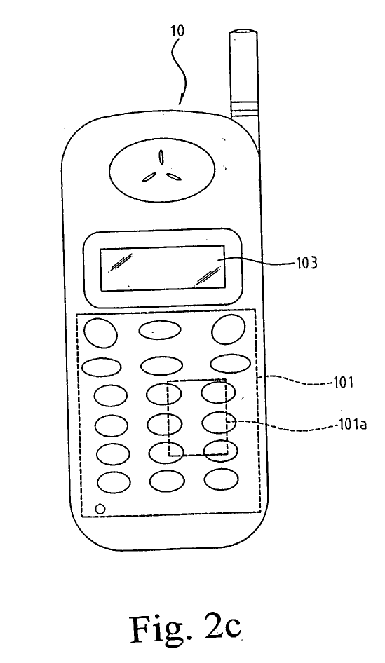

FIG. 1 shows the system block diagram of the present invention of a workstation-type mini computer. The workstation-type mini computer 10 includes a motherboard 101 having at least a processor 101a, a small display 103, a wired receiving interfaces 105, a wireless receiving interfaces 107, and a wireless audio-video signal transmitter 109. The small display 103 is connected to the motherboard 101 for displaying results from the operation of the processor 101a. The wired receiving interface 105 receives electric signals through an electric cable 30a from an external wired key-in device 30 (either of a keyboard, a mouse, and a touch-control panel); the electric cable 30a bridges the external wired key-in device 30 and the wired receiving interface 105. The wireless receiving interface 107 receives electric signals from an external wireless key-in device 40 (either of a keyboard, a mouse, and a touch-control panel) by a wireless transmission means. The wireless audio-video signal transmitter 109, working together with a wireless audio-video signal receiver 111, is used for transmitting the contents of an output AV signal from the motherboard 101 to a remote large-scaled display monitor 20; the wireless audio-video signal receiver 111 is connected to the large-scaled display monitor 20. The output AV signal from the motherboard 101 to the wireless audio-video signal receiver 111 is the same as the output AV signal to the small display 103 and the speaker of a mini electronic device. In the workstation-type mini computer 10, the output audio-video signals may be switched to the wireless audio-video signal transmitter 109 for being transmitted to the wireless audio-video signal receiver 111, so that the output AV signal can be displayed on the large-scaled display monitor 20. It is a further function that the small display 103 of the workstation-type mini computer 10 may be switched off by the first switch 103a when the output AV signal is displayed by the large-scaled display monitor 20, for saving electric power. FIG. 2a is a three-dimensional view of an embodiment of the present invention as a handheld computer, according to the structure of the present invention shown in FIG. 1. FIG. 2b is a three-dimensional view of an embodiment of the present invention as a personal digital assistant (PDA), according to the structure of the present invention shown in FIG. 1. FIG. 2c is a three-dimensional view of an embodiment of the present invention as a mobile phone, according to the structure of the present invention shown in FIG. 1. Being capable of switching key-in devices and output display monitors, the embodiments of the present invention, a handheld computer, a personal digital assistant, a mobile phone, or any of other similar electronic devices, can be connected to an external wired or wireless key-in device (30 or 40). By the same token, the output display can be switch to a remote large-scaled display monitor 20 by sending the output AV signal from a wireless audio-video signal transmitter 109 to a wireless audio-video signal receiver 111.

The second switch 109a is used for switching on/off the wireless audio-video signal transmitter 109. The processor 101a can be a central processing unit (CPU) or any of other processors capable of computing. The small display 103 can be a LCD display monitor.

The large-scaled display monitor 20 used with the present invention can be a television set, a cathodes-ray tube display monitor, or a display monitor of any other kind.

Although the present invention is disclosed by the above embodiments, it is obvious that the same invention may be varied in many ways. If all such modifications are obvious to one skilled in the art, they should not to be regarded as a departure from the spirit and scope of the present invention, and therefore should be included within the scope of the following claims.

What is claimed is:

1. A workstation-type mini computer capable of switching key-in devices and output display monitors comprising
a motherboard having at least one processor,
a small display connected to said motherboard,
a wired receiving interface connected to said motherboard;
said wired receiving interface receiving signals from an external wired key-in device being one of a keyboard, a mouse, and a touch-control panel through an electric cable;
said electric cable bridging said wired receiving interface and said external wired key-in device,
a wireless receiving interface for receiving signals from an external wireless key-in device by a wireless transmission means, and
a wireless audio-video signal transmitter for transmitting output audio-video signals generated in said motherboard to a wireless audio-video-signal receiver; said wireless audio-video signal receiver receiving and then relaying said output audio-video signals to a large-scaled display monitor for display.

2. The workstation-type mini computer of claim 1, wherein said workstation-type mini computer is a handheld computer.

3. The workstation-type mini computer of claim 1, wherein said workstation-type mini computer is a personal digital assistant (PDA).

4. The workstation-type mini computer of claim 1, wherein said workstation-type mini computer is a mobile phone.

5. The workstation-type mini computer of claim 1, wherein said small display is a LCD display monitor.

6. The workstation-type mini computer of claim 1, wherein said large-scaled display monitor is a television set.

7. The workstation-type mini computer of claim 1, wherein said large-scaled display monitor is a cathode-ray tube monitor or other display monitor.

8. The workstation-type mini computer of claim 1, wherein said processor is a central processing unit (CPU).

9. The workstation-type mini computer of claim 1, wherein said workstation-type mini computer further comprises a switch for switching said small display on and off.

10. The workstation-type mini computer of claim 1, wherein said workstation-type mini computer further comprises a switch for switching said wireless audio-video signal transmitter on and off.
